(19) United States
(12) Patent Application Publication
(10) Pub. No.: US 2022/0168906 A1
(43) Pub. Date: Jun. 2, 2022

(54) STRUCTURE OF CLAW SOLENOID

(71) Applicant: Yi-Ho Lin, Kaohsiung City (TW)

(72) Inventor: Yi-Ho Lin, Kaohsiung City (TW)

(21) Appl. No.: 17/534,465

(22) Filed: Nov. 24, 2021

(30) Foreign Application Priority Data
Nov. 30, 2020 (TW) 109142004

(51) Int. Cl. B25J 15/02; B25J 15/00; A63F 9/30

(52) U.S. Cl. CPC B25J 15/0246; A63F 9/30; B25J 15/0028

(57) ABSTRACT

A structure of a solenoid of a claw includes a solenoid tube, which is provided with multiple coils that are arranged circumferentially on an outside surface at intervals. The coils have one end connected with a control switch and an opposite connected with a power supply source. A vertical tube is disposed in the solenoid tube and is provided therein with multiple magnetic elements to respectively correspond to the coils. A bottom of the vertical tube is pivotally connected to fingers of the claw. The control switch includes a chip electrically connection with multiple control elements that are connected to the coils respectively. A temperature switch is arranged on a wall of the solenoid tube to detect a temperature thereof. The temperature switch is electrically connected to the control switch. The power supply source is connected to the coils, the control switch, and the temperature switch.

### TECHNICAL FIELD OF THE INVENTION

The present invention relates to a structure of a solenoid of a claw, and more particularly to a structure of a claw solenoid that enhance grip strength and avoid coil overheating.

### DESCRIPTION OF THE PRIOR ART

Existing claw machines, also known toy cranes or claw vending machines, provides a function of object-gripping entertainment and also a function of merchandise vending. People of all kinds, such as young children, students, general people, or senior people, may enjoy the object-gripping games to gain a prize. There are also shop owners or business traders provide unique or limited products in the claw machines to be gripped and gained by players, for the purposes of increasing the value and popularity of the products and also for promotion of sales. For such reasons, the claw machines are in fact a widely popular and long lasting mode of game and product vending.

The existing claw machine is made up of a claw that is operated by energizing a coil to attract a magnetic element combined with the claw to move upward, in order to close the claw to grip an object (see for example Taiwan Utility M437196). The present inventor has made a further progress by providing a claw including two sets of coil, in which a distance between the two sets of coil is adjustable and a magnetic element is also adjustable in length thereof to suit for needs, so that fingers of the claw may adapt to different sizes and different opening angles (see for example Taiwan Patent I696485f).

However, regardless whether the claw includes one set or two sets of coils, the grip strength or force offered by the claw is generally fixed. Consequently, the grip strength has to be modified according to the size of the claw machine and the size and weight of prize objects. When the grip strength is adjusted to a relatively high level, an electrical voltage that is necessary input must be relatively high, and a long-term use would cause heating of the coil, leading to lowering of the grip strength, or even overheating that makes the machine down and failing for continuing the operation of prize gripping, eventually resulting in economic loss of the business and lowering the interesting of the players for playing the games.

### SUMMARY OF THE INVENTION

An object of the present invention is to improve the deficiency discussed above by providing a structure of a claw solenoid that increases a grip strength and avoids coil overheating.

To achieve the above object, the present invention provides a claw solenoid structure that comprises a solenoid tube, a vertical tube, a control switch, a temperature switch, and a power supply source, wherein:

the solenoid tube is adapted to be mounted in claw, and the solenoid tube is provided with multiple coils that are arranged circumferentially on an outside surface at intervals, the coils having one end connected with the control switch and an opposite connected with the power supply source;

the vertical tube is disposed in an interior of the solenoid tube, and the vertical tube is provided, in an interior thereof, with multiple magnetic elements, the magnetic elements being arranged to respectively correspond to the coils of the solenoid tube, a separating element being arranged between every two of the magnetic elements; and a bottom portion of the vertical tube is pivotally connected to claw fingers of the claw, so that upward and downward movements of the vertical tube in the interior of the solenoid tube drives the claw fingers for inward gripping and outward expanding, respectively;

the control switch comprises a chip, the chip being in electrical connection with multiple control elements, the control elements being respectively connected with the coils provided on the solenoid tube;

the temperature switch is arranged on an external tubular wall of the solenoid tube to detect a tubular wall temperature of the solenoid tube; and the temperature switch; and

the power supply source is in connection with the coils provided on the solenoid tube, the control switch, and the temperature switch to supply electrical power for operation thereof; and the power supply source is operable to supply voltages of different levels to suit for different needs.

Based on the structure described above, a structure of a claw solenoid that increases a grip strength and avoids coil overheating is provided.

### BRIEF DESCRIPTION OF THE DRAWINGS

FIG. 1 is a schematic view showing the present invention.

FIG. 2 is a schematic view showing another embodiment of the present invention.

### DETAILED DESCRIPTION OF THE PREFERRED EMBODIMENT

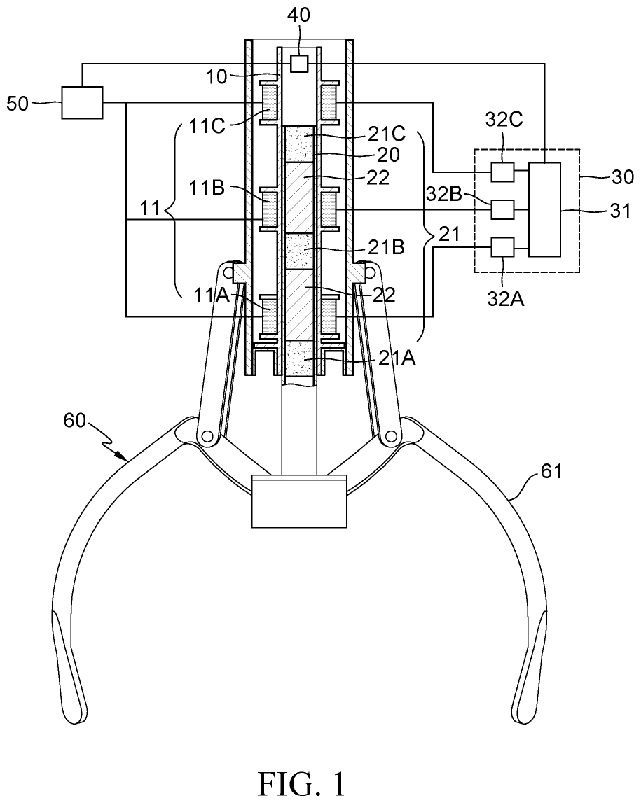

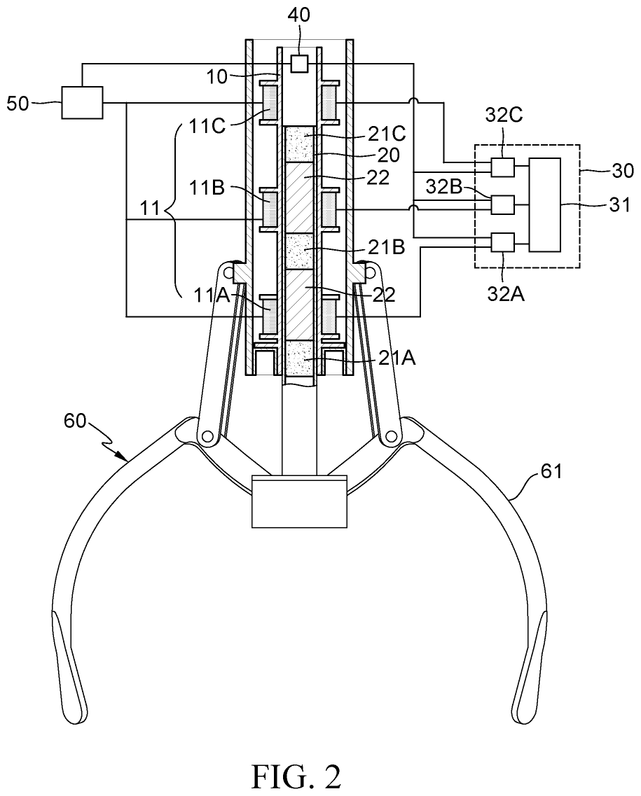

The technical solution that the present invention adopts to achieve such an object will be described below in detail with reference to the embodiments shown in FIGS. 1 and 2:

As shown in FIG. 1, the present invention provides a claw solenoid structure, which comprises a solenoid tube 10, a vertical tube 20, a control switch 30, a temperature switch 40, and a power supply source 50.

The solenoid tube 10 (referring to FIG. 1) is mounted in a claw 60. Multiple sets of coils 11 are arranged circumferentially on an outside surface of the solenoid tube 10 at intervals (3 sets of coils 11A, 11B, 11C being provided in the example shown in the drawing). An end of the coils 11A, 11B, 11C is connected with the control switch 30, and an opposite end is connected with the power supply source 50.

The vertical tube 20 (referring to FIG. 1) is disposed in an interior of the solenoid tube 10. The vertical tube 20 is provided, in an interior thereof, with multiple sets of magnetic elements 21 (3 sets of magnetic elements 21A, 21B, 21C being provided in the example shown in the drawing). The magnetic elements 21A, 21B, 21C are respectively corresponding to the coils 11A, 11B, 11C provided on the solenoid tube 10, and a separating element 22 is arranged between every two of the magnetic elements 21A, 21B, 21C (two separating elements being provided in the example shown in the drawing). A bottom portion of the vertical tube 20 is pivotally connected to claw fingers 61 of the claw 60, so that upward and downward movements of the vertical tube 20 in the interior of the solenoid tube 10 drives the claw fingers 61 for inward contracting and thus gripping and outward expanding, respectively.

The control switch 30 (referring to FIG. 1) comprises a chip 31. The chip 31 is in electrical connection with multiple control elements 32 (3 control elements 32A, 32B, 32C being provided in the example shown in the drawing). The control elements 32A, 32B, 32C are respectively connected with the coils 11A, 11B, 11C provided on the solenoid tube 10.

The temperature switch 40 (referring to FIG. 1) is arranged on an external tubular wall of the solenoid tube 10 to detect a tubular wall temperature of the solenoid tube 10. The temperature switch 40 is in connection with the control switch 30 and the power supply source 50.

The power supply source 50 (referring to FIG. 1) is in connection with the coils 11A, 11B, 11C provided on the solenoid tube 10 and the control switch 30 and the temperature switch 40 to supply electrical power for operation thereof. The power supply source 50 is operable to supply different voltages to suit for different needs.

Based on the structure described above, when the power supply source 50 supplies an input of a relatively small voltage (such as 16V), the chip 31 of the control switch 30 may, at the same time, read and determine the input voltage is relatively small, and the chip 31 signals the one of the control elements 32 that is at a most distal location (such as the control element 32C in the illustration of the drawings) to drive the one of the coils 11 that is at a lowest location of the solenoid tube 10 (such as the coil 11C in the illustration of the drawings) for being in a conducting condition, so that the coil 11C is supplied with electricity and energized to generate a magnetic field, and meanwhile, the one of the magnetic elements 21 that is at a lowest location inside the vertical tube 20 (such as the magnetic element 21C in the illustration of the drawings) is subjected to an magnetic effect of attraction or repulsion to move upward and at the same time drives the vertical tube 20 for an upward movement, by which the claw fingers 62 are driven to contract inward. When the chip 31 signals the control element 32C not to control and set the coil at the lowest location of the solenoid tube 10 in a conducting condition, the coil 11C no longer generates the magnetic field, and the vertical tube 20 is acted upon by the gravity to fall down and open the claw fingers 62.

When the power supply source 50 supplies an input of a relatively large voltage (such as 32V), the chip 31 of the control switch 30 may, at the same time, read and determine the input voltage is relatively large, and the chip 31 signals the control elements 32 that are respectively at the distal location and a middle location (such as the control elements 32C, 32B in the illustration of the drawings) to drive the coils 11 that are at the lowest location and a middle location of the solenoid tube 10 (such as the coils 11C, 11B in the illustration of the drawings) for being in a conducting condition, so that the two coils 11B, 11C are supplied with electricity and energized to generate a magnetic field, and meanwhile, the magnetic elements 21 that are at the lowest location and a middle location inside the vertical tube 20 (such as the magnetic elements 21C, 21B in the illustration of the drawings) are subjected to an magnetic effect of attraction or repulsion to move upward and at the same time drive the vertical tube 20 for an upward movement, by which the claw fingers 62 are driven to contract inward.

When the power supply source 50 supplies an input of a maximum available voltage (such as 48V), the chip 31 of the control switch 30 may, at the same time, read and determine the input voltage is of the maximum level, and the chip 31 signals all the three control elements 32A, 32B, 32C to drive all the three coils 11A, 11B, 11C of the solenoid tube 10 for being in a conducting condition, so that the coils 11A, 11B, 11C are supplied with electricity and energized to generate a magnetic field, and meanwhile, the three magnetic elements 21A, 21B, 21C inside the vertical tube 20 are subjected to an magnetic effect of attraction or repulsion to move upward and at the same time drive the vertical tube 20 for an upward movement, by which the claw fingers 62 are driven to contract inward.

When the coils 11 have been energized or supplied with a voltage that is persistently kept at a high level for an extended period to cause heating of the coils 11, the temperature switch 40 detects an event that the temperature of the external tubular wall of the solenoid tube 10 becomes relatively high (such as 60° C.), and the temperature switch 40 drives the control switch 30 make the coils 11A, 11B, 11C non-conducting and interrupting the supply of electricity, in order to protect the coils 11A, 11B, 11C from overheating. Once the temperature switch 40 detects and identifies that the temperature of the external tubular wall of the solenoid tube 10 drops to a tolerable level (such as being lower than 50° C.), the temperature switch 40 drives the control switch 30 again to make the coils 11A, 11B, 11C conducting for receiving the supply of electricity, with which the game of gripping a prize object may resume.

Following the above description, the temperature switch 40 can be made in electrical connection with the chip 31 of the control switch 30 (as shown in FIG. 1), in order to allow the temperature switch 40 to transmit a temperature signal to the chip 31 to be read and identified by the chip 31 for subsequent transmission of a signal to the control elements 32A, 32B, 32C to enable the control elements 31A, 31B, 31C to control the coils 11A, 11B, 11C provided on the solenoid tube 10 to be in a conducting condition or not. In an alternative embodiment, the temperature switch 40 can be set in direct electrical connection with the control elements 32A, 32B, 32C of the control switch 30 (as shown in FIG. 2), in order to allow the temperature switch 40 to directly signal the control elements 31A, 31B, 31C to control the coils 11A, 11B, 11C to be in a conducting condition or not.

Thus, based on the above description, one can learn that the present invention provides the following advantages:

(1) The present invention provides, according to requirement, multiple sets of coils 11 on a solenoid tube 10, and magnetic elements 21 are mounted inside a vertical tube 20 to respectively correspond to the coils 11, and a control switch 30 is operable to adjust and control the number of the coils 11 that are set in a conducting condition according to an input level of voltage, so that a grip strength of claw fingers 61 can be adjusted and controlled accordingly, this being advantageous in respect of use convenience and adaptability for gripping prize objects of various sizes and weights.

(2) The present invention provides an arrangement that includes multiple sets of coils 11 and magnetic elements 21, which can effectively increase the magnetic effect of attraction/repulsion between the coils 11 and the magnetic elements 21, so as to increase the grip strength and response speed of claw fingers 61, allowing the claw fingers 61 to quickly grip a prize object and also allowing the claw fingers 61 reliably grip a prize object, with the prize object being not readily detached.

(3) The present invention provides a structure in which a wall of a solenoid tube 10 is provided with a temperature switch 40 to detect the temperature of the solenoid tube 10, wherein coils 11 provided on the solenoid tube 10 may transmit a temperature to the solenoid tube 10, the temperature switch 40 responds to the temperature of the solenoid tube 10 to control, by means of a control switch 30, if the coils 10 are supplied with electricity or not, so as to effective protect the coils 11, preventing the coils 11 from damage resulting from overheating and thus extending the service life of the present invention.

I claim:

1. A claw solenoid structure, comprising a solenoid tube, a vertical tube, a control switch, a temperature switch, and a power supply source, wherein:
the solenoid tube is adapted to be mounted in claw, and the solenoid tube is provided with multiple coils that are arranged circumferentially on an outside surface at intervals, the coils having one end connected with the control switch and an opposite connected with the power supply source;
the vertical tube is disposed in an interior of the solenoid tube, and the vertical tube is provided, in an interior thereof, with multiple magnetic elements, the magnetic elements being arranged to respectively correspond to the coils of the solenoid tube, a separating element being arranged between every two of the magnetic elements; and a bottom portion of the vertical tube is pivotally connected to claw fingers of the claw, so that upward and downward movements of the vertical tube in the interior of the solenoid tube 10 drives the claw fingers for inward gripping and outward expanding, respectively;
the control switch comprises a chip, the chip being in electrical connection with multiple control elements, the control elements being respectively connected with the coils provided on the solenoid tube;
the temperature switch is arranged on an external tubular wall of the solenoid tube to detect a tubular wall temperature of the solenoid tube; and the temperature switch; and
the power supply source is in connection with the coils provided on the solenoid tube, the control switch, and the temperature switch to supply electrical power for operation thereof; and the power supply source is operable to supply voltages of different levels to suit for different needs.
